(19) United States
(12) Patent Application Publication
(10) Pub. No.: US 2026/0086360 A1
(43) Pub. Date: Mar. 26, 2026

(54) SMART GLASSES

(71) Applicant: AAC ACOUSTIC TECHNOLOGIES (SHENZHEN) CO., LTD., Shenzhen (CN)

(72) Inventors: Xiuliang Xie, Shenzhen (CN); Qingshan Xu, Shenzhen (CN); Hongyan Tao, Shenzhen (CN)

(21) Appl. No.: 18/977,850

(22) Filed: Dec. 11, 2024

Related U.S. Application Data
(63) Continuation of application No. PCT/CN2024/121149, filed on Sep. 25, 2024.

(51) Int. Cl. G02B 27/01; G02C 5/14

(52) U.S. Cl. CPC G02B 27/0149; G02C 5/146

(57) ABSTRACT

Smart glasses are provided, including a frame assembly and two temple mechanisms. The two temple mechanisms are respectively fixed to two opposite ends of the frame assembly. The two temple mechanisms include two connecting components respectively fixed to the two opposite ends of the frame assembly, two female connecting assemblies respectively hinged to ends of the two connecting components, and two temple assemblies respectively inserted into the two female connecting assemblies. Through respectively inserting the two temple assemblies into the two female connecting assemblies, each female connector is fixed and locked with a corresponding female connecting assembly; when the two temple assemblies are pulled out by external force, the two temple assemblies are separated from the frame assembly to complete the quick disassembly, a frame of the smart glasses is easily assembled and disassembled, thereby proving better user experience.

### TECHNICAL FIELD

The present disclosure relates to the field of glasses structures, and in particular to smart glasses.

### BACKGROUND

Smart glasses refer to wearable eyewear devices that possess an independent operating system similar to that of smart terminals and are capable of achieving various functions through installation of corresponding software, the smart glasses are recently proposed and one of wearable smart devices that have good prospects. The smart glasses are simple and convenient in use and are compact in size, thereby being increasingly popular for users to view business presentation.

The smart glasses in the related art include a frame assembly, a connecting structure fixed to two opposite ends of the fame, temple hinges hinged to the connecting structure through fixing screws, and temples respectively hinged to the temple hinges. Through unfolding or folding the temple hinges, the users easily wear the smart glasses or store the smart glasses.

However, in the related art, the temple hinges and the temples of the smart glasses are mostly fixed using screws or adhesive bonding, and the temple hinges and the connecting structure of the smart glasses are fixed through the screws, which is inconvenient in quick replacement of a frame of the smart glasses, thereby leading to poor user experience.

Therefore, it is necessary to provide a pair of smart glasses to solve above problems.

### SUMMARY

A technical problem to be solved by the present disclosure is to provide smart glasses enabling quick assembly and disassembly and having good user experience.

In order to solve the technical problem, the present disclosure provides the smart glasses, including a frame assembly and two temple mechanisms. The two temple mechanisms are respectively fixed to two opposite ends of the frame assembly. The two temple mechanisms include two connecting components, two female connecting assemblies, and two temple assemblies. The two connecting components are respectively fixed to the two opposite ends of the frame assembly, the two female connecting assemblies are respectively hinged to ends of the two connecting components away from the frame assembly, and the two temple assemblies are respectively inserted into the two female connecting assemblies from ends of the two female connecting assemblies away from the frame assembly to form a snap-fit. The two temple assemblies are respectively detachably connected to the two female connecting assemblies.

As an improvement, each of the two female connecting assemblies includes a female connector main body, a mounting groove, an elastic piece, a hinge base, and two limiting positions. Each female connector main body is rectangular-shaped, each mounting groove is recessed inward from one end of a corresponding female connector main body close to a corresponding one of the two temple assemblies, each elastic piece is U-shaped and is fixed in a corresponding mounting groove, each hinge base protrudes outward from an outer peripheral side of a corresponding female connector main body, and each two limiting positions are recessed inward from two opposite sides of a groove wall of a corresponding mounting groove. Each elastic piece includes a bottom edge, two first side edges, two second side edges, and two protruding portions. Each bottom edge is fixed to a groove bottom of a corresponding mounting groove, two ends of each bottom edge are bent and extend to respectively form corresponding two first side edges, each two first side edges respectively extend to form corresponding two second side edges, and each two second side edges extend opposite to each other to form corresponding two protruding portions. Each two first side edges respectively abut against the two opposite sides of the groove wall of a corresponding mounting groove, each two second side edges are respectively aligned with corresponding two limiting positions. Each of the two connecting components is assembled with a corresponding hinge base to form a hinge. Each of the two temple assemblies includes a temple and a male connector fixed to one end of the temple, each male connector includes a male connector main body and two concave grooves, each male connector main body is fixed to a corresponding temple and is rectangular-shaped, and each two concave grooves are recessed inward respectively from two opposite sides of a corresponding male connector main body. Each male connector main body is inserted into a corresponding mounting groove, and each two protruding portions are respectively clamped and embedded into corresponding two concave grooves to form a lock.

As an improvement, each male connector is made of a metal material, and each elastic piece is made of a stainless steel material.

As an improvement, the groove bottom of each mounting groove and a corresponding elastic piece are integrally formed through laser welding.

As an improvement, each female connector and a corresponding temple are integrally formed through in-mold injection molding or adhesive bonding.

As an improvement, at least one positioning column is disposed in each mounting groove, each at least one positioning column protrudes from one side of a corresponding female connector main body away from the frame assembly. At least one positioning hole is defined on each bottom edge and penetrates through each bottom edge, each at least one positioning column is inserted into and fixed in a corresponding at least one positioning hole.

As an improvement, at least one limiting groove is recessed from one end of each male connector main body away from the frame assembly, each at least one limiting groove is defined corresponding to corresponding at least one limiting column.

As an improvement, the smart glasses includes two bolts, each of the two connecting components is hinged to the corresponding hinge base through a corresponding one of the two bolts.

Compared with the related art, in the smart glasses of the present disclosure, the two temple mechanisms are respectively fixed to the two opposite ends of the frame assembly. The two temple mechanisms include the two connecting components, the two female connecting assemblies, and the two temple assemblies. The two connecting components are respectively fixed to the two opposite ends of the frame assembly, the two female connecting assemblies are respectively hinged to the ends of the two connecting components away from the frame assembly, and the two temple assemblies are respectively inserted into the two female connecting assemblies from the ends of the two female connecting assemblies away from the frame assembly to form the snap-fit. The two temple assemblies are respectively detachably connected to the two female connecting assemblies. Through respectively inserting the two temple assemblies into the two female connecting assemblies, each female connector is fixed and locked with a corresponding female connecting assembly; when the two temple assemblies are pulled out by external force, the two temple assemblies are separated from the frame assembly to complete the quick disassembly, a frame of the smart glasses is easily assembled and disassembled, thereby proving better user experience.

### BRIEF DESCRIPTION OF DRAWINGS

In order to more clearly illustrate technical solutions in embodiments of the present disclosure, drawings required in description of the embodiments are briefly described below, and obviously, the accompanying drawings in following description are merely some embodiments of the present disclosure, and for those who skilled in the art, other drawings may be obtained according to the accompanying drawings without creative efforts, in the drawings:

FIG. 1 is a structural schematic diagram of smart glasses of the present disclosure.

FIG. 2 is an exploded schematic diagram of FIG. 1.

FIG. 3 is a cross-sectional schematic diagram taken along the line A-A of FIG. 1.

FIG. 4 is an enlarged schematic diagram of portion B shown in FIG. 3.

FIG. 5 is a structural schematic diagram of a female connector main body of the present disclosure.

FIG. 6 is a structural schematic diagram of an elastic piece of the present disclosure.

FIG. 7 is a structural schematic diagram of a male connector of the present disclosure.

Reference numerals in the drawings: 100. smart glasses; 1. frame assembly; 2. temple mechanism; 21. connecting component; 22. female connecting assembly; 221. female connector main body; 222. mounting groove; 223. elastic piece; 2231. bottom edge; 2232. first side edge; 2233. second side edge; 2234. protruding portion; 224. hinge base; 23. temple assembly; 231. temple; 232. male connector; 2321. male connector main body; 2322. concave groove; 3. positioning column; 4. positioning hole; 5. limiting position; 6. limiting groove; 7. bolt.

### DETAILED DESCRIPTION OF EMBODIMENTS

Technical solutions in embodiments of the present disclosure are clearly and completely described below with reference to accompanying drawings of the embodiments of the present disclosure. Obviously, the described embodiments are only a part but not all of the embodiments of the present disclosure. All other embodiments obtained by those who skilled in the art based on the embodiments of the present disclosure without creative efforts shall fall within a protection scope of the present disclosure.

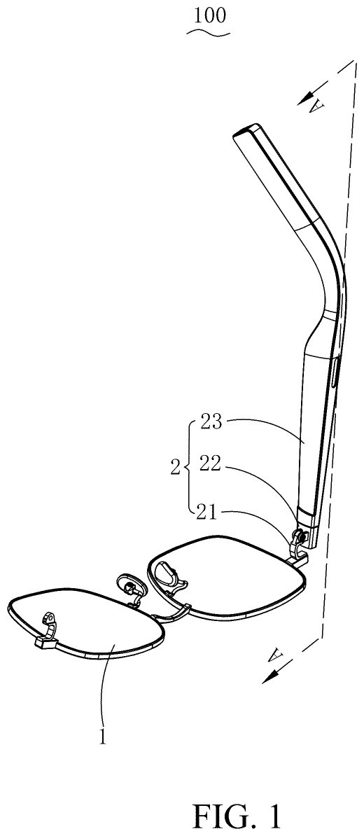

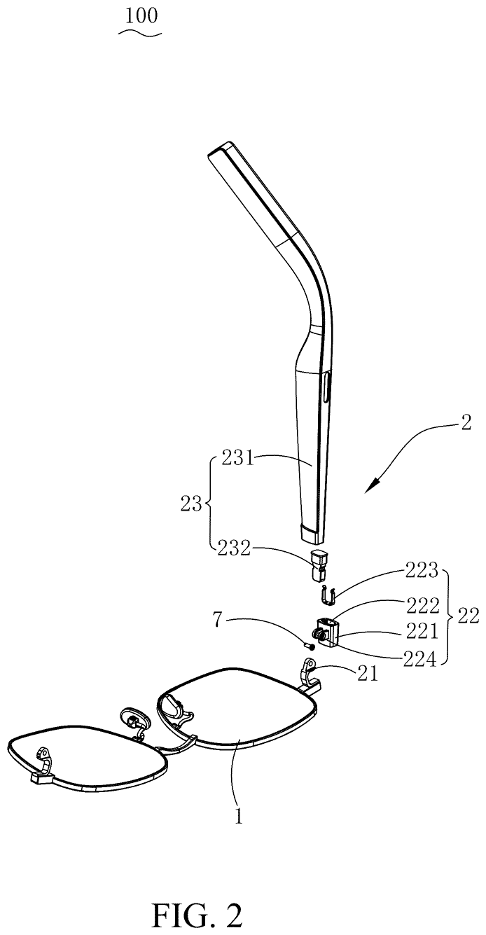

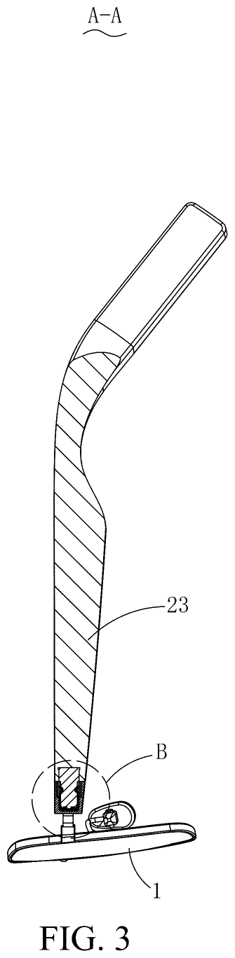

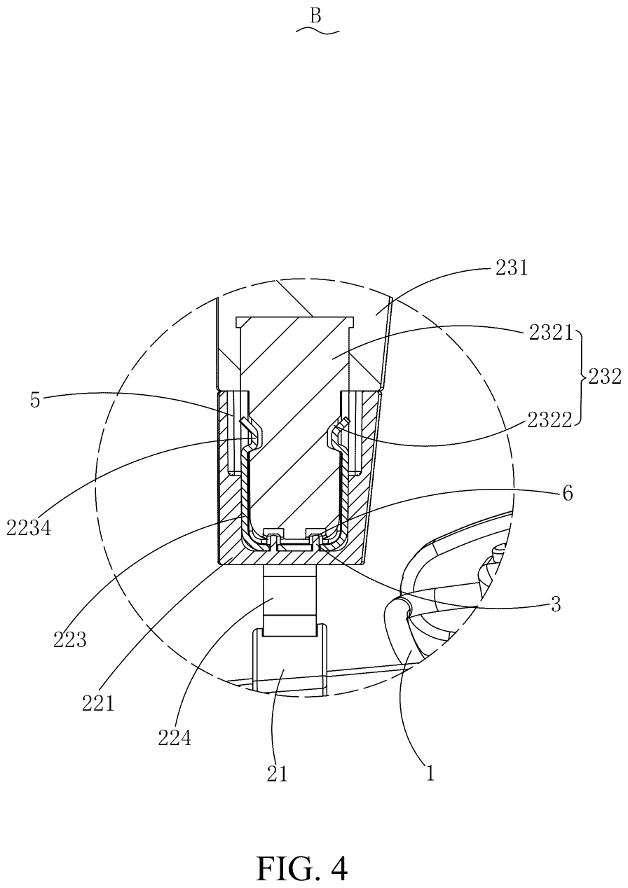

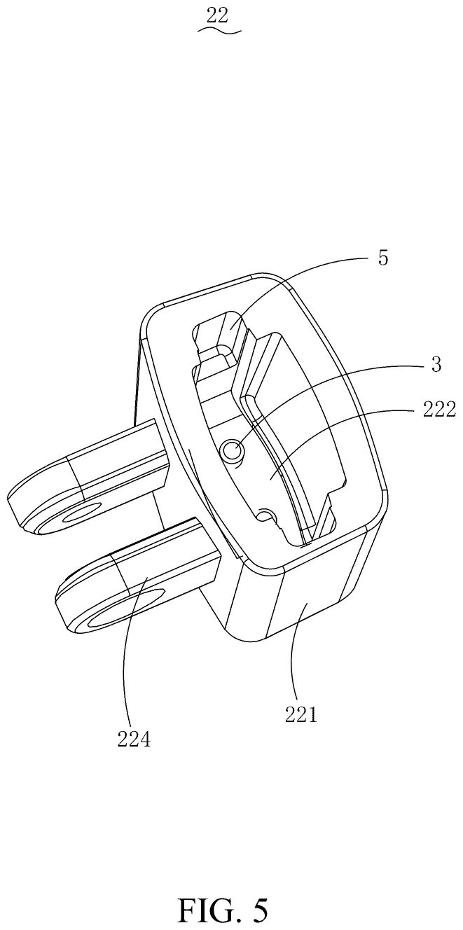

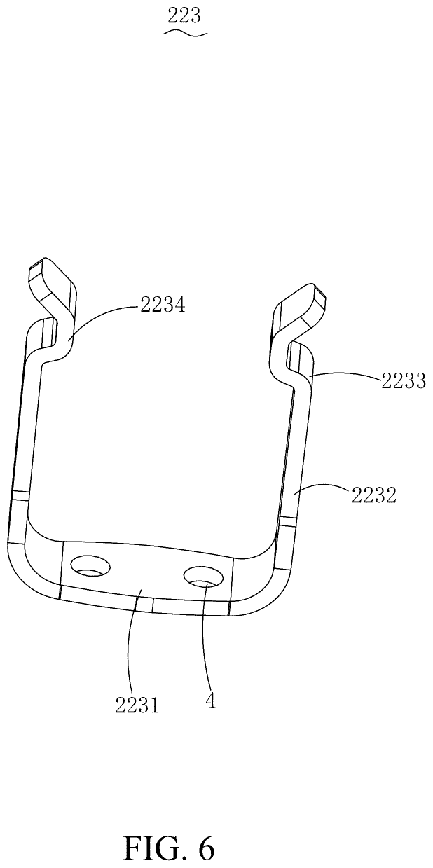

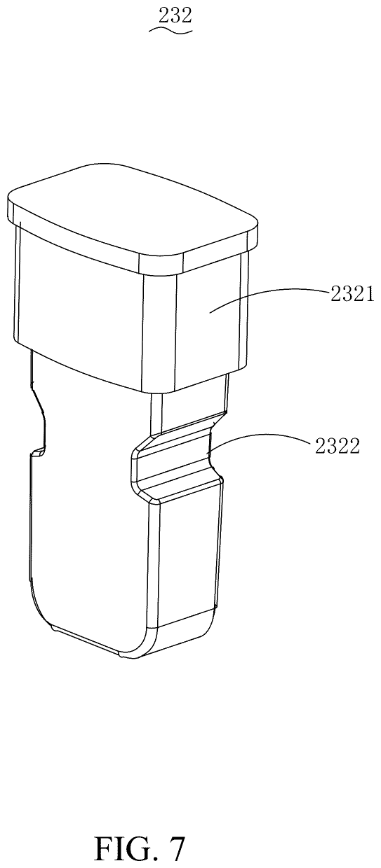

Please refer to FIGS. 1-7, the present disclosure provides smart glasses 100, including a frame assembly 1 and two temple mechanisms 2. The two temple mechanisms 2 (only one is shown in the drawings) are respectively fixed to two opposite ends of the frame assembly 1. The frame assembly 1 is configured to support the two temple mechanisms 2.

The two temple mechanisms 2 include two connecting components 21, two female connecting assemblies 22, and two temple assemblies 25. The two connecting components 21 are respectively fixed to the two opposite ends of the frame assembly 1, the two female connecting assemblies 22 are respectively hinged to ends of the two connecting components 21 away from the frame assembly 1, and the two temple assemblies 23 are respectively inserted into the two female connecting assemblies 22 from ends of the two female connecting assemblies 22 away from the frame assembly 1 to form a snap-fit. The two temple assemblies 23 are respectively detachably connected to the two female connecting assemblies 22. Through respectively inserting the two temple assemblies 23 into the two female connecting assemblies 22, each female connector 232 is fixed and locked with a corresponding female connecting assembly 22; when the two temple assemblies 23 are pulled out by external force, the two temple assemblies 23 are separated from the frame assembly 1 to complete quick disassembly, a frame of the smart glasses is easily assembled and disassembled, thereby proving better user experience.

In the embodiments, each of the two female connecting assemblies 22 includes a female connector main body 221, a mounting groove 222, an elastic piece 223, a hinge base 224, and two limiting positions 5. Each female connector main body 221 is rectangular-shaped, each mounting groove 222 is recessed inward from one end of a corresponding female connector main body 221 close to a corresponding one of the two temple assemblies 23, each elastic piece 223 is U-shaped and is fixed in a corresponding mounting groove 222, each hinge base 224 protrudes outward from an outer peripheral side of a corresponding female connector main body 221, and each two limiting positions 5 are recessed inward from two opposite sides of a groove wall of a corresponding mounting groove 222. Each of the two connecting components 21 is assembled with a corresponding hinge base 224 to form a hinge, each elastic piece 223 is made of a stainless steel material.

Each elastic piece 223 includes a bottom edge 2231, two first side edges 2232, two second side edges 2233, and two protruding portions 2234. Each bottom edge 2231 is fixed to a groove bottom of a corresponding mounting groove 222, two ends of each bottom edge 2231 are bent and extend to respectively form corresponding two first side edges 2232, each two first side edges 2232 respectively extend to form corresponding two second side edges 2233, and each two second side edges 2233 extend opposite to each other to form corresponding two protruding portions 2234. Each two first side edges 2232 respectively abut against a corresponding mounting groove 222, each two second side edges 2233 are respectively disposed in corresponding two limiting positions 5. In this way, each two second side edges 2233 is elastically deformed in the corresponding two limiting positions 5, and a corresponding male connector 232 is more securely clamped.

Each of the two temple assemblies 23 includes a temple 231 and a male connector 232 fixed to one end of the temple 231, each male connector 232 is inserted into and fixed in a corresponding elastic piece 223 to achieve a secure connection. Each male connector 232 is made of a metal material. Each male connector 232 includes a male connector main body 2321 and two concave grooves 2322, each male connector main body 2321 is fixed to a corresponding temple 231 and is rectangular-shaped, and each two concave grooves 2322 are recessed inward respectively from two opposite sides of a corresponding male connector main body 2321. Each male connector main body 2321 is inserted into a corresponding mounting groove 222, and each two protruding portions 2234 are respectively clamped and embedded into corresponding two concave grooves 2322 to form a lock.

Specifically, through hinging each hinge base 224 with a corresponding one of the two connecting components 21, the corresponding female connector main body 221 is easily adjusted for folding, thereby opening or folding a corresponding one of temple assemblies 23. Through inserting each male connector 232 into the corresponding mounting groove 222 of the corresponding female connector main body 221, each elastic piece 223 made of the stainless steel material is extruded and deformed and then presses a corresponding male connector 232, so that each of the two female connecting assemblies 22 and a corresponding male connector 232 are securely locked with each other; and when the two temple assemblies 23 are pulled out by the external force, each elastic piece 223 made of the stainless material is deformed by force to separate from the corresponding male connector 232, so that each male connector 232 is quickly separated from a corresponding one of the two female connecting assemblies 22 to complete the quick disassembly.

Specifically, through inserting each of the two temple assemblies 23 into the mounting groove 222 of a corresponding one of the two female connecting assemblies 22, a corresponding elastic piece 223 is deformed by force to form corresponding two protruding portions 2234 to clamp and embed into corresponding two concave grooves 2322, so that each of the two temple assemblies 23 is locked with the corresponding one of the two female connecting assemblies 22. When the two temple assemblies 23 are pulled out by the external force, each elastic piece 223 made of the stainless material is deformed by force, so that the corresponding two protruding portions 2234 are deformed to separate from the corresponding two concave grooves 2322, so that each of the two temple assemblies 23 is quickly separated from a corresponding one of the two female connecting assemblies 22 to complete the quick disassembly.

In the embodiments, the groove bottom of each mounting groove 222 and a corresponding elastic piece 223 are integrally formed through laser welding. In this way, each elastic piece 223 is more securely fixed, thereby enhancing structural strength.

In the embodiments, each female connector 232 and a corresponding temple 231 are integrally formed through in-mold injection molding or adhesive bonding. In this way, each female connector 232 and the corresponding temple 231 are more securely fixed, thereby enhancing structural strength.

In the embodiments, each two limiting positions 5 are further recessed from one side, away from the frame assembly 1, of the corresponding mounting groove 222.

In the embodiments, at least one positioning column 3 is disposed in each mounting groove 222, each at least one positioning column 3 protrudes from one side of a corresponding female connector main body 221 away from the frame assembly 1. At least one positioning hole 4 is defined on each bottom edge 2231 and penetrates through each bottom edge 2231, each at least one positioning column 3 is inserted into and fixed in a corresponding at least one positioning hole 4, which is convenient for position, mount, and fix a corresponding elastic piece 223.

In the embodiments, at least one limiting groove 6 is recessed from one end of each male connector main body 2321 away from the frame assembly 1, each at least one limiting groove 6 is defined corresponding to corresponding at least one limiting column 3. In this way, each male connector main body 2321 is prevented from abutting against a corresponding at least one limiting column 3 in a process of being inserted into the corresponding one female connector main body 221, thereby avoiding damage.

In the embodiments, the smart glasses 100 includes two bolts 7, each of the two connecting components 21 is hinged to the corresponding hinge base 224 through a corresponding one of the two bolts 7, which facilitates the hinge between each of the two connecting components 21 and the corresponding hinge base 224.

Compared with the related art, in the smart glasses 100 of the present disclosure, the two temple mechanisms 2 are respectively fixed to the two opposite ends of the frame assembly 1. The two temple mechanisms 2 include the two connecting components 21, the two female connecting assemblies 22, and the two temple assemblies 25. The two connecting components 21 are respectively fixed to the two opposite ends of the frame assembly 1, the two female connecting assemblies 22 are respectively hinged to the ends of the two connecting components 21 away from the frame assembly 1, and the two temple assemblies 23 are respectively inserted into the two female connecting assemblies 22 from the ends of the two female connecting assemblies 22 away from the frame assembly 1 to form the snap-fit. The two temple assemblies 23 are respectively detachably connected to the two female connecting assemblies 22. Through respectively inserting the two temple assemblies 23 into the two female connecting assemblies 22, each female connector 232 is fixed and locked with the corresponding female connecting assembly 22; when the two temple assemblies 23 are pulled out by the external force, the two temple assemblies 23 are separated from the frame assembly 1 to complete the quick disassembly, the frame of the smart glasses is easily assembled and disassembled, thereby proving the better user experience.

The foregoing are merely embodiments of the present disclosure, and it should be noted that, for those who skilled in the art, improvements can be made without departing from the concepts of the present disclosure, but these are all within the protection scopes of the present disclosure.

What is claimed is:

1. Smart glasses, comprising:
a frame assembly; and
two temple mechanisms;
wherein the two temple mechanisms are respectively fixed to two opposite ends of the frame assembly;
the two temple mechanisms comprise two connecting components, two female connecting assemblies, and two temple assemblies;
the two connecting components are respectively fixed to the two opposite ends of the frame assembly, the two female connecting assemblies are respectively hinged to ends of the two connecting components away from the frame assembly, and the two temple assemblies are respectively inserted into the two female connecting assemblies from ends of the two female connecting assemblies away from the frame assembly to form a snap-fit; and
the two temple assemblies are respectively detachably connected to the two female connecting assemblies.

2. The smart glasses according to claim 1, wherein each of the two female connecting assemblies comprises a female connector main body, a mounting groove, an elastic piece, a hinge base, and two limiting positions;
each female connector main body is rectangular-shaped, each mounting groove is recessed inward from one end of a corresponding female connector main body close to a corresponding one of the two temple assemblies, each elastic piece is U-shaped and is fixed in a corresponding mounting groove, each hinge base protrudes outward from an outer peripheral side of a corresponding female connector main body, and each two limiting positions are recessed inward from two opposite sides of a groove wall of a corresponding mounting groove;
each elastic piece comprises a bottom edge, two first side edges, and two second side edges, two protruding portions;
each bottom edge is fixed to a groove bottom of a corresponding mounting groove, two ends of each bottom edge are bent and extend to respectively form corresponding two first side edges, each two first side edges respectively extend to form corresponding two second side edges, and each two second side edges extend opposite to each other to form corresponding two protruding portions;
each two first side edges respectively abut against the two opposite sides of the groove wall of a corresponding mounting groove, each two second side edges are respectively aligned with corresponding two limiting positions;
each of the two connecting components is assembled with a corresponding hinge base to form a hinge;
each of the two temple assemblies comprises a temple and a male connector fixed to one end of the temple, each male connector comprises a male connector main body and two concave grooves, each male connector main body is fixed to a corresponding temple and is rectangular-shaped, and each two concave grooves are recessed inward respectively from two opposite sides of a corresponding male connector main body; and
each male connector main body is inserted into a corresponding mounting groove, and each two protruding portions are respectively clamped and embedded into corresponding two concave grooves to form a lock.

3. The smart glasses according to claim 2, wherein each male connector is made of a metal material, and each elastic piece is made of a stainless steel material.

4. The smart glasses according to claim 3, wherein the groove bottom of each mounting groove and a corresponding elastic piece are integrally formed through laser welding.

5. The smart glasses according to claim 4, wherein each female connector and a corresponding temple are integrally formed through in-mold injection molding or adhesive bonding.

6. The smart glasses according to claim 5, wherein at least one positioning column is disposed in each mounting groove, each at least one positioning column protrudes from one side of a corresponding female connector main body away from the frame assembly; and
at least one positioning hole is defined on each bottom edge and penetrates through each bottom edge, each at least one positioning column is inserted into and fixed in a corresponding at least one positioning hole.

7. The smart glasses according to claim 6, wherein at least one limiting groove is recessed from one end of each male connector main body away from the frame assembly, each at least one limiting groove is defined corresponding to corresponding at least one limiting column.

8. The smart glasses according to claim 2, wherein the smart glasses comprises two bolts, each of the two connecting components is hinged to the corresponding hinge base through a corresponding one of the two bolts.
